(19) United States
(12) Patent Application Publication
(10) Pub. No.: US 2025/0083804 A1
(43) Pub. Date: Mar. 13, 2025

(54) WINGLET TRAILING EDGE VENTING

(71) Applicant: Textron Aviation Inc., Wichita, KS (US)

(72) Inventors: Bryan C. HINSON, Wichita, KS (US); Corey W. HAGEMEISTER, Wichita, KS (US); Robert G. WIEGERS, Wichita, KS (US); Kelly R. LAFLIN, Wichita, KS (US)

(21) Appl. No.: 18/463,066

(22) Filed: Sep. 7, 2023

(51) Int. Cl. B64C 21/02

(52) U.S. Cl. CPC B64C 21/025

(57) ABSTRACT

Airfoil venting systems are provided which include an airfoil (e.g., a winglet or an aircraft wing) having leading and trailing edges and an internal channel adapted to being fluid-connected to an on-board aircraft system which in use requires air to be exhausted. A series of venting apertures are positioned on at least a portion of the trailing edge of the airfoil and fluid-connected to the internal channel whereby air from the on-board aircraft system can be exhausted therethrough.

### FIELD

The embodiments disclosed herein relate generally to airfoils, such as aircraft wings and winglets, provided with venting systems. In preferred forms, the embodiments disclosed herein relate to airfoils that include trailing edge vent systems.

### BACKGROUND

Certain onboard aircraft systems, such as aircraft cabin ventilation and bleed air ice protection systems, require that air be exhausted during use. Typically, the exhaust air associated with such onboard systems is discharged to the ambient environment through vents or louvers located on the lower surface of the airfoil. However, discharging exhaust air in such a manner creates aerodynamic disruption and attendant drag.

While the aerodynamic disruption and drag can be minimized by locating the discharge vents at an outboard section of the airfoil, there still exists a need for improvement. It is towards fulfilling such a need that the embodiments disclosed herein are directed.

### SUMMARY

The airfoil venting systems according to the embodiments disclosed herein will generally comprise an airfoil having leading and trailing edges, and an internal channel adapted to being fluid-connected to an on-board aircraft system which in use requires air to be exhausted. A series of venting apertures are positioned on at least a portion of the trailing edge of the airfoil and fluid-connected to the internal channel whereby air from the on-board aircraft system can be exhausted therethrough.

Some embodiments will include a manifold cavity internally of the airfoil which fluid connects the internal channel to the venting apertures. The airfoil may be, for example, a winglet or an outboard section of a wing. In those embodiments where the airfoil is a winglet, the venting apertures may be positioned along an inboard, an outboard and/or an intermediate section of the trailing edge of the winglet. When the airfoil is a wing, the venting apertures may be positioned along an outboard section of the trailing edge of the wing.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a schematic perspective view of an airfoil that includes an embodiment of the trailing edge venting system according to the present invention;

FIG. 2 is an enlarged view of the venting system as shown in FIG. 1; and

FIG. 3 is a schematic perspective view of another embodiment of the trailing edge venting system according to the present invention.

### DETAILED DESCRIPTION OF EMBODIMENTS

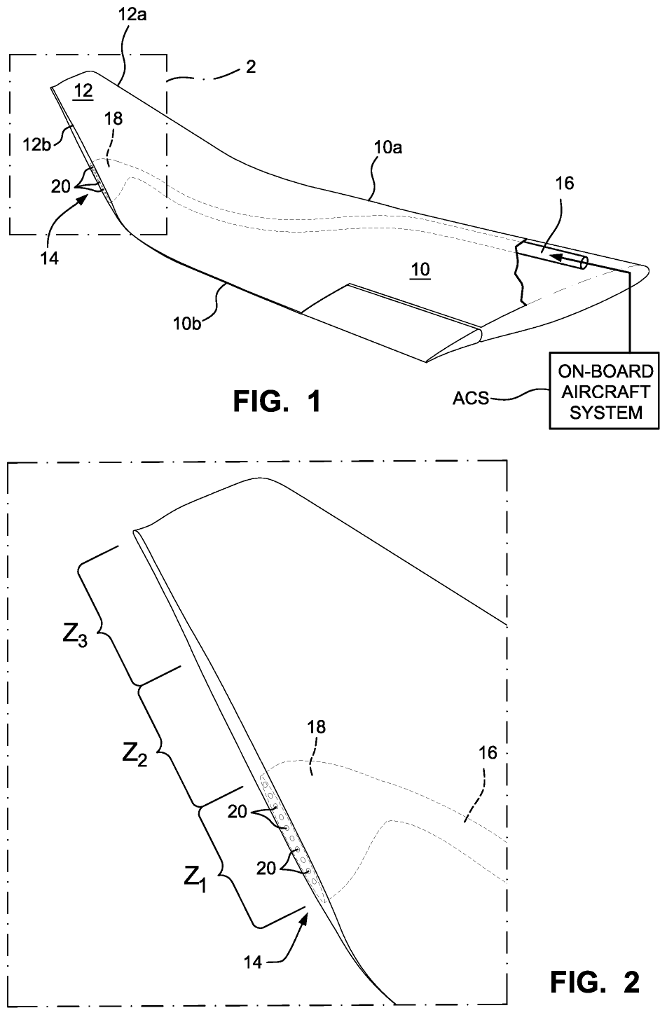

Accompanying FIGS. 1 and 2 depict a port wing 10 and associated winglet 12 each of which includes leading and trailing edges 10a, 10b and 12a, 12b, respectively. It will be appreciated in this regard that although only a port wing is depicted the discussion hereinbelow equally applies to the starboard wing (not shown) as the latter is a mirror image of the former. The wing 10 is provided with venting system 14 that includes an internal channel 16 which terminates in an internal manifold cavity 18 and an aligned series of vent apertures 20 in fluid communication with the manifold cavity 18 and positioned along at least a portion of the trailing edge 12b of the winglet 12.

The internal channel 16 receives air to be exhausted from an onboard aircraft system ACS which may, for example, be a cabin environmental ventilation system or a thermal anti-icing system using bleed air from the compressor section of a turbine engine. Although the internal channel 16 is depicted schematically as a tube or conduit, those in this art will realize that the channel 16 may be in the form of a cavity that is defined spanwise within the leading edge of the wing 10.

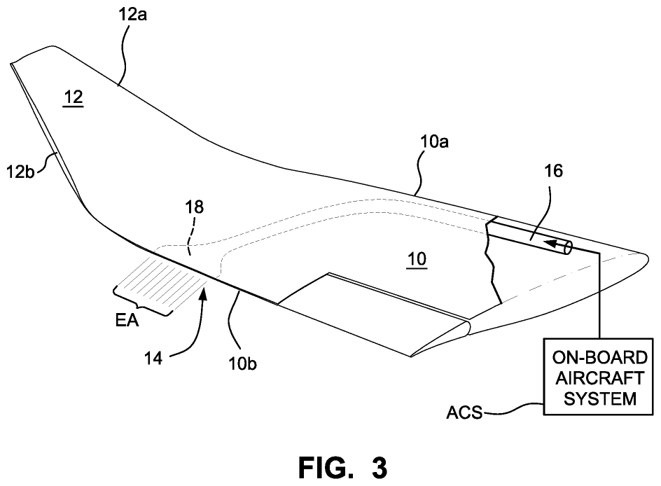

As is perhaps better shown in FIG. 2, the venting apertures 20 are depicted as being aligned along an inboard section Z1 of the trailing edge 12b of the winglet 12. However, the venting apertures 20 may alternatively or additionally be provided along an intermediate section Z2 and/or an outboard section Z3 of the winglet 12 as may be required for proper venting of the exhaust air supplied by the onboard aircraft system ACS. An alternative embodiment is depicted in FIG. 3 as allowing exhaust air (schematically identified by the reference EA) through aligned venting apertures (not shown) in the trailing edge 10b of the wing 10.

It is believed that less aerodynamic disturbances are realized by venting exhaust air through the venting apertures 20 aligned along at least a portion of the trailing edge 12b of the winglet 12 and/or along an outboard portion of the trailing edge 10b of the wing 10. Moreover, the exhaust air vented from the venting apertures 20 at the trailing edges 12b and/or 10b of the winglet 12 and/or wing 10, respectively, may contribute to added thrust thereby improving aircraft performance.

While reference has been made to particular embodiments of the invention, various modifications within the skill of those in the art may be envisioned. Therefore, it is to be understood that the invention is not to be limited to the disclosed embodiments, but on the contrary, is intended to cover various modifications and equivalent arrangements included within the spirit and scope thereof.

1. An airfoil venting system comprising:
an airfoil having leading and trailing edges,
an internal channel adapted to being fluid-connected to an onboard aircraft system which in use requires air to be exhausted; and
an aligned series of venting apertures formed in at least a portion of the trailing edge of the airfoil and fluid-connected to the internal channel, wherein
exhaust air from the onboard aircraft system is discharged rearwardly from the trailing edge of the airfoil through the venting apertures.

2. The airfoil venting system according to claim 1, further comprising an internal manifold cavity fluid connecting the internal channel to the venting apertures.

3. The airfoil venting system according to claim 1, wherein the airfoil is a winglet or an outboard section of a wing.

4. The airfoil venting system according to claim 1, wherein the airfoil is a winglet, and wherein the venting apertures are positioned along an inboard, an outboard and/or an intermediate section of the trailing edge of the winglet.

5. The airfoil venting system according to claim 1, wherein the airfoil is a wing, and wherein the venting apertures are positioned along an outboard section of the trailing edge of the wing.

6. The An aircraft which comprises the airfoil venting system according to claim 1.

7. An aircraft comprising:
an onboard aircraft system which in use requires air to be exhausted;
an airfoil having leading and trailing edges; and
a venting system to vent exhaust air from the onboard aircraft system from the trailing edge of the airfoil, wherein the venting system comprises:
(i) an channel internally provided in the airfoil which is fluid-connected to the onboard aircraft system to receive exhaust air therefrom; and
(ii) an aligned series of venting apertures formed in at least a portion of the trailing edge of the airfoil and fluid-connected to the channel, wherein
exhaust air from the onboard aircraft system is discharged rearwardly from the trailing edge of the airfoil through the venting apertures.

8. The aircraft according to claim 7, wherein the airfoil venting system further comprises an internal manifold cavity fluid connecting the internal channel to the venting apertures.

9. The aircraft according to claim 7, wherein the airfoil is a winglet or an outboard section of a wing.

10. The aircraft according to claim 7, wherein the airfoil is a winglet, and wherein the venting apertures are positioned along an inboard, an outboard and/or an intermediate section of the trailing edge of the winglet.

11. The aircraft according to claim 7, wherein the airfoil is a wing, and wherein the venting apertures are positioned along an outboard section of the trailing edge of the wing.
